(19) United States
(12) Patent Application Publication
(10) Pub. No.: US 2015/0022465 A1
(43) Pub. Date: Jan. 22, 2015

(54) TOUCHPAD FOR USER TO VEHICLE INTERACTION

(71) Applicant: Hajime Yamada, Rancho Palos Verdes, CA (US)

(72) Inventor: Hajime Yamada, Rancho Palos Verdes, CA (US)

(73) Assignee: HONDA MOTOR CO., LTD., Tokyo (JP)

(21) Appl. No.: 13/945,491

(22) Filed: Jul. 18, 2013

(51) Int. Cl. G06F 3/0481

(52) U.S. Cl. CPC G06F 3/04817
USPC 345/173

(57) ABSTRACT

One or more embodiments of techniques or systems for user to vehicle interaction are provided herein. A touchpad can include sensing areas and contoured edges. The sensing areas and contoured edges can be configured to receive inputs. These inputs can be routed to user interface (UI) applications. Additionally, aspects of the UI application can be displayed. Because portions of the touchpad can be contoured, a user or driver can keep their eyes on the road while operating the vehicle, rather than looking away from the windshield or road toward an instrument display. In one or more embodiments, hints related to one or more of the UI applications can be provided to alert a user that potential inputs may be used or that additional features may be available. In this manner, safer driving may be promoted by mitigating how often a driver looks away from the road.

### BACKGROUND

Vehicles are often equipped with navigation units or multimedia units. Sometimes, these units have touch screen displays. For example, a navigation unit may have a touch screen that accepts inputs from a user. However, objects on a touch screen display may be hidden to a user when the user moves his or her finger over an object to select the object. Additionally, touch screens may be sensitive to dirt or dust or suffer from an accidental press when the user hovers his or her finger over the touch screen. Further, fingerprints from the user may remain on the display after the user touches the touch screen to make a selection.

### SUMMARY

This summary is provided to introduce a selection of concepts in a simplified form that are described below in the detailed description. This summary is not intended to be an extensive overview of the claimed subject matter, identify key factors or essential features of the claimed subject matter, nor is it intended to be used to limit the scope of the claimed subject matter.

One or more embodiments of techniques or systems for user to vehicle interaction are provided herein. Generally, when a driver is driving a vehicle it may be desirable to mitigate an amount of time or a frequency of how often a driver glances away from the road. For example, if a navigation unit of a vehicle is located on a center console of a vehicle and utilizes a touch screen for input (e.g., entering a destination on a soft keyboard) the driver or user of the navigation unit may look down at the navigation unit or touch screen interface and thus look away from the road, thereby causing a distraction. In one or more embodiments, a touchpad can include one or more sensing areas and one or more contoured edges. These contoured edges enable a user or a driver to situate their hands or fingers around the touchpad or provide tactile feedback so the user is more aware of a layout of the touchpad. In one or more embodiments, the touchpad may be contoured or have one or more recesses, peaks, grooved, etc. The contour of the touchpad can facilitate a user orienting himself or herself with the touchpad while keeping their eyes focused on the road. Additionally, the touchpad can be placed in an ergonomically accessible position, such as on an armrest or on a steering wheel of a vehicle. Because the touchpad can receive inputs, a display component can be configured to display a user interface (UI) or UI applications at a location where the user may not necessarily reach or touch on a frequent basis, such as a heads up display (HUD) projected on the windshield of the vehicle.

In one or more embodiments, a UI component can route one or more of the inputs to one or more of the UI applications to facilitate interaction between the user and the vehicle or a system of the vehicle, such as a navigation system, etc. A hint component can provide hints for the user to alert the user of one or more potential inputs for the UI or UI applications. In other words, the hints may be indicative of actions that are possible or features that are available which the user may otherwise not be aware of. As an example, the hint component may alert a user of potential inputs for features that the user has not used before or within a time period.

The following description and annexed drawings set forth certain illustrative aspects and implementations. These are indicative of but a few of the various ways in which one or more aspects are employed. Other aspects, advantages, or novel features of the disclosure will become apparent from the following detailed description when considered in conjunction with the annexed drawings.

### DESCRIPTION OF THE DRAWINGS

Aspects of the disclosure are understood from the following detailed description when read with the accompanying drawings. Elements, structures, etc. of the drawings may not necessarily be drawn to scale. Accordingly, the dimensions of the same may be arbitrarily increased or reduced for clarity of discussion, for example.

FIG. 1 is an illustration of an example touchpad for user to vehicle interaction, according to one or more embodiments.

FIG. 2 is an illustration of an example system for user to vehicle interaction, according to one or more embodiments.

FIG. 3 is an illustration of an example system for user to vehicle interaction, according to one or more embodiments.

FIG. 4 is an illustration of an example system for user to vehicle interaction, according to one or more embodiments.

FIG. 5 is an illustration of an example flow diagram of a method for user to vehicle interaction, according to one or more embodiments.

FIG. 6 is an illustration of an example computer-readable medium or computer-readable device including processor-executable instructions configured to embody one or more of the provisions set forth herein, according to one or more embodiments.

FIG. 7 is an illustration of an example computing environment where one or more of the provisions set forth herein are implemented, according to one or more embodiments.

### DETAILED DESCRIPTION

Embodiments or examples, illustrated in the drawings are disclosed below using specific language. It will nevertheless be understood that the embodiments or examples are not intended to be limiting. Any alterations and modifications in the disclosed embodiments, and any further applications of the principles disclosed in this document are contemplated as would normally occur to one of ordinary skill in the pertinent art.

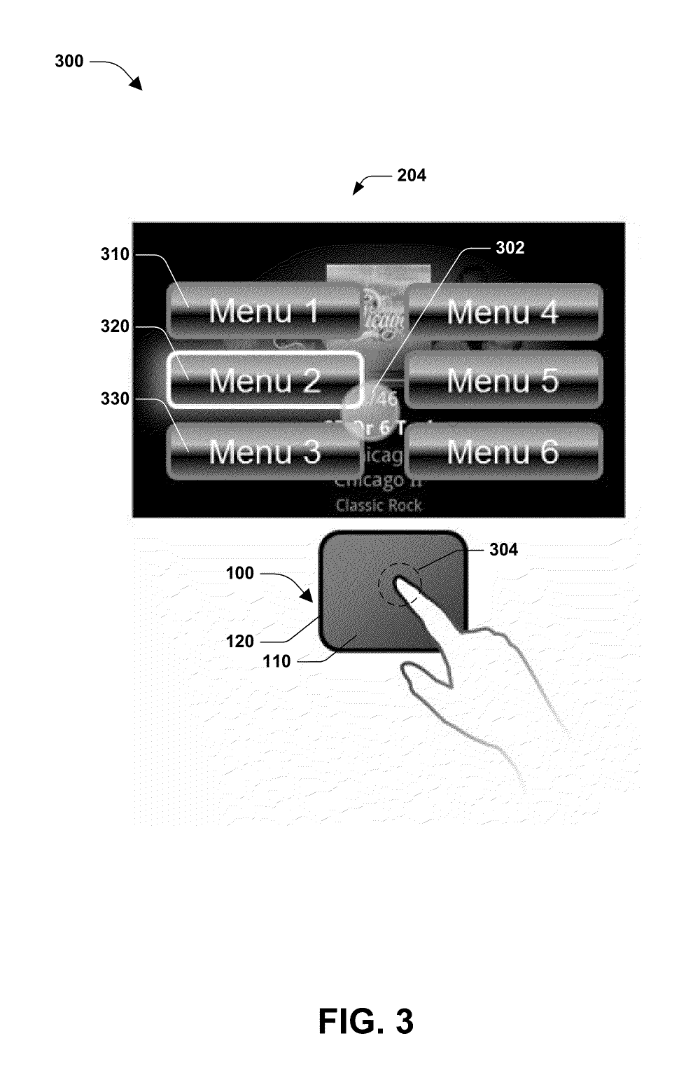

For one or more of the figures herein, one or more boundaries, such as boundary 304 of FIG. 3, for example, are drawn with different heights, widths, perimeters, aspect ratios, shapes, etc. relative to one another merely for illustrative purposes, and are not necessarily drawn to scale. For example, because dashed or dotted lines are used to represent different boundaries, if the dashed and dotted lines were drawn on top of one another they would not be distinguishable in the figures, and thus are drawn with different dimensions or slightly apart from one another, in one or more of the figures, so that they are distinguishable from one another. As another example, where a boundary is associated with an irregular shape, the boundary, such as a box drawn with a dashed line, dotted lined, etc., does not necessarily encompass an entire component in one or more instances. Conversely, a drawn box does not necessarily encompass merely an associated component, in one or more instances, but can encompass a portion of one or more other components as well.

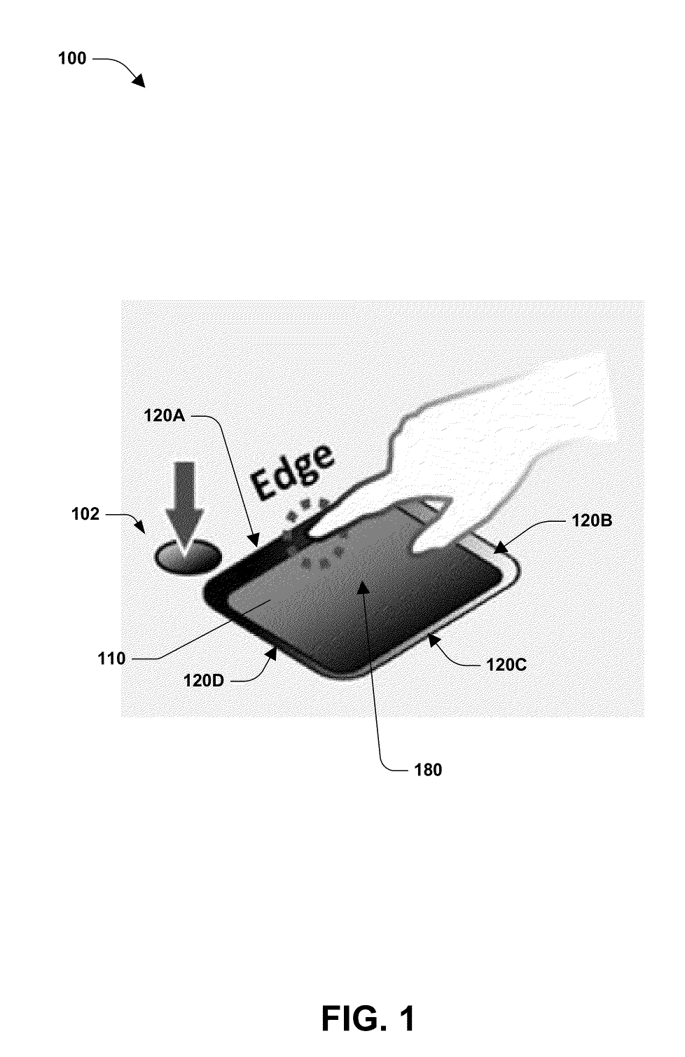

FIG. 1 is an illustration of an example touchpad 100 for user to vehicle interaction, according to one or more embodiments. The touchpad 100 of FIG. 1 can include one or more sensing areas 110 and one or more contoured edges 120A, 120B, 120C, and 120D. Additionally, the touchpad 100 can include a switch 102 or a button. In this way, the touchpad 100 can be configured to receive one or more inputs from the switch 102, one of the sensing areas 110, or one of the contoured edges 120A, 120B, 120C, or 120D. One or more of the inputs received by the touchpad 100 can be transmitted or routed to a user interface (UI) or one or more UI applications.

In one or more embodiments, one or more portions of the touchpad 100 can be contoured or textured to provide a tactile guide for a user interacting with the touchpad 100 while operating a vehicle. In other words, the touchpad 100 may be shaped with one or more recesses or one or more peaks to enable a user or driver to ‘feel’ their way around the touchpad 100 and maintain focus on the road, thereby promoting safer driving. Additionally, the touchpad 100 may be textured so that the user can identify a location where their finger is on the touchpad 100 without necessarily looking at the touchpad 100.

For example, the sensing area 110 can be shaped with a recess (although other contours may be used, such as peaks, grooves, etc.) at a location, such as location 180, within the sensing area 110. In FIG. 1, the touchpad 100 could be formed to have a recess in the center 180. As a result of this recess or contour, when a user places his or her finger on the touchpad 100, the finger may naturally slide to the recess or to the center 180 of the touchpad 100, thereby orienting the user with an initial position of the finger relative to the touchpad 100. By providing the recess within the touchpad 100, a user would have a point of reference when initiating interaction with a UI or the vehicle. According to one or more embodiments, the recess may be located at locations other than location 180. Additionally, the touchpad 100 may be formed with one or more recesses or peaks to provide users with one or more points of reference.

In one or more embodiments, the sensing area 110 of the touchpad 100 can correspond to a display screen, display area, display, or a display component. That is, for example, the upper right corner of the sensing area 110 can correspond to the upper right corner of a display. In this example, when a user touches the upper right corner of the sensing area 110, a cursor may appear or move to the upper right cover of the display. If a touchpad 100 has a recess, such as at location 180, a user's finger may naturally slide or fall into the recess. As a result of this, when the finger reaches the recess, the display component may display a cursor in the center of the display area. In this way, one or more recesses, peaks, bulges, or contours can allow a user to establish a point of reference for a user interface (UI) having a touchpad based input.

Additionally, a recess within a touchpad 100 can be used as an unlocking mechanism for a UI. That is, when one or more portions of the sensing area 110 (or one or more of the sensing areas) not associated with the recess receive input or are touched by a user, the UI can be programmed not to respond to such inputs, for example. In other words, a UI can be ‘locked’ until an input is received from a recessed portion of the sensing area 110. Stated yet another way, the UI may be ‘unlocked’ when a user places his or her finger within a recess located on the touchpad 100, thereby mitigating ‘accidental’ inputs, for example. In other embodiments, one or more of the contoured edges 120A, 120B, 120C, or 120D can be used to ‘lock’ or ‘unlock’ access to a UI. For example, concurrent input from contoured edges 120A and 120C may unlock the UI. In one or more other embodiments, different contours, bulges, protrusions, recesses, peaks, valleys, grooves, etc. may be formed on the touchpad 100 or the sensing area 110 to provide the user with one or more points of reference that can guide the user to provide inputs via the touchpad 100, while mitigating the user or driver from distractions when operating a vehicle.

In one or more embodiments, the sensing area 110 of the touchpad 100 can be textured to provide the point of reference. For example, a portion of the sensing area 110 at location 180 can be formed with a rough surface, different material, different coefficient of friction, etc. relative to other portions of the sensing area 110 surrounding location 180. This enables a user or a driver to ‘feel’ his or her way around the touchpad 110 and ‘find’ a point of reference (which is the center location 180 in this example).

The touchpad 100 can include one or more contoured edges, such as contoured edges 120A, 120B, 120C, and 120D, for example. These edges can be contoured or textured similarly to the sensing area 110. For example, one or more of the contoured edges 120A, 120B, 120C, or 120D can be elevated relative to one or more sensing areas 110. In other examples, one or more portions of the sensing area 110 can be elevated relative to one or more of the contoured edges 120A, 120B, 120C, or 120D. Because the edges 120A, 120B, 120C, and 120D are contoured, a user is provided a point of reference between his or her finger and the touchpad 100. This means that the user can find his or her way around the touchpad 100 by feel, rather than looking away from the road, thereby mitigating the user from breaking his or her concentration while driving.

One or more of the contoured edges 120A, 120B, 120C, or 120D can be at an angle to a surface of the sensing area 110. This can facilitate gravitation of the user's fingers toward the sensing area 110 of the touchpad 100. In this way, a user can locate and operate the touchpad 100 by feel, rather than by sight. Further, when the edges 120A, 120B, 120C, or 120D are contoured, swiping or attempted inputs from outside the sensing area 110 can be mitigated by the tactile feedback provided by the contour. In this way, one or more of the contoured edges 120A, 120B, 120C, or 120D can be used to ‘clear’ an edge around the touchpad 100, thereby clarifying non-operational or non-sensing portions or areas from sensing portions or areas or operational portions of the touchpad 100.

The touchpad 100 of FIG. 1 can be configured to receive a variety of inputs. For example, touch input can be received from one or more sensing areas or portions of the sensing area 110. That is, one or more sensing areas or portions of a sensing area 110 can be configured to sense one or more inputs. Touch input may also be received from one or more of the contoured edges 120A, 120B, 120C, or 120D. For example, one or more of the contoured edges 120A, 120B, 120C, or 120D can be configured to sense one or more inputs.

One or more inputs received from the touchpad 100 can be treated differently based on the source of the input. For example, a swipe that begins at contoured edge 120A and includes sensing area 110 may be considered different than a swipe that begins and ends on sensing area 110. As another example, yet another type of swipe can begin at contoured edge 120A, include sensing area 110, and end at contoured edge 120B. In yet another example, a swipe can include a trace of a contoured edge. In one or more embodiments, inputs may be differentiated based on inclusion of one or more contoured edges 120A, 120B, 120C, or 120D. Inputs may be associated with one or more sensing areas, one or more contoured edges, switches, etc. based on the source of the input. In other words, a swipe across 120A, 110, and 120C may be associated with the respective portions, regions, or areas. In one or more embodiments, swipes may be treated similarly whether including a contoured edge or not including a contoured edge. In other words, a swipe that begins at 120A and ends at 110 may be treated similarly to a swipe that begins and ends within the sensing area 110.

The touchpad 100 can be configured to receive click inputs, toggle inputs, or time based inputs. For example, the sensing area 110 can be configured to click, similarly to a mouse button. Similarly, one or more of the contoured edges 120A, 120B, 120C, or 120D or switch 102 may be configured to click. For example, one or more of the contoured edges can be clickable or touch sensitive. In one or more embodiments, the sensing area 110, one or more of the contoured edges 120A, 120B, 120C, or 120D, or the switch 102 can be configured to toggle between two or more states. For example, the switch 102 can be configured to toggle between an ‘on’ state and an ‘off’ state.

In one or more embodiments, inputs received from the touchpad 100 can be interpreted differently based on an amount of time a sensing area 110 or a contoured edge 120A, 120B, 120C, or 120D is in contact with a user. For example, an input where a finger touches a contoured edge or a sensing area 110 for one second can be interpreted differently from an input where a finger is in contact with the contoured edge or sensing area for five seconds. In other words, inputs can be time sensitive. In one or more embodiments, time sensitive inputs can further be differentiated by whether or not the input is stationary (e.g., a user holds his or her finger in place) or moving. In one or more embodiments, inputs received by the touchpad 100 can be multi-touch or multi-finger sensitive. For example, a swipe with two fingers can be different than a swipe made using three fingers. In this way, one or more inputs may be received by the touchpad 100, one or more sensing areas 110, one or more contoured edges 120A, 120B, 120C, or 120D, or a switch 102.

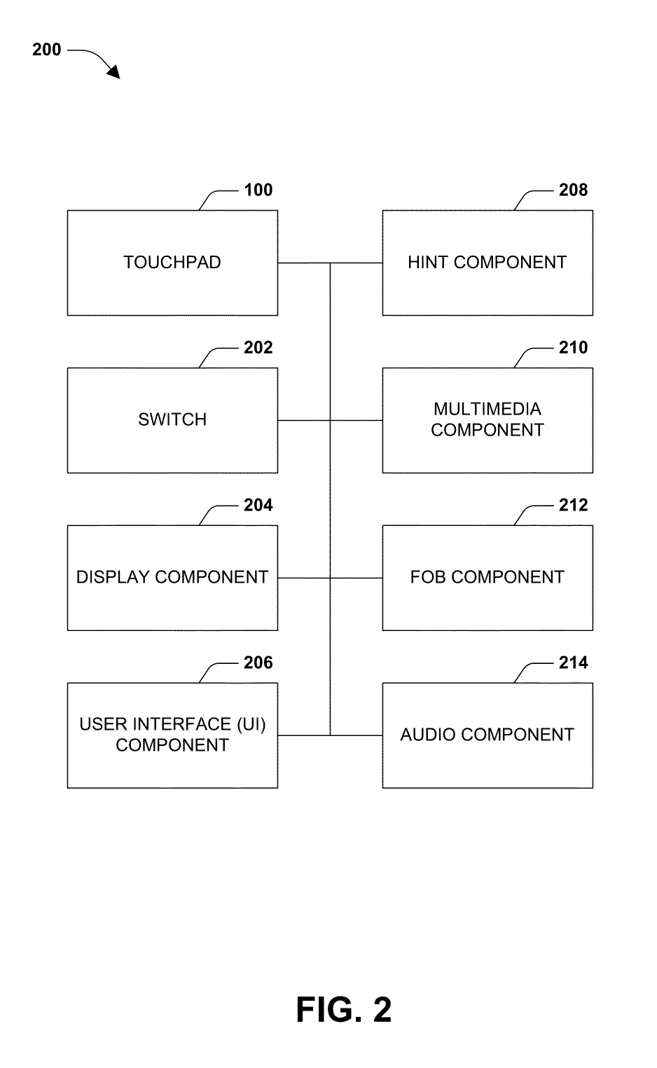

FIG. 2 is an illustration of an example system 200 for user to vehicle interaction, according to one or more embodiments. In one or more embodiments, the system 200 of FIG. 2 includes a touchpad 100, a switch 202, a display component 204, a user interface (UI) component 206, a hint component 208, a multimedia component 210, a fob component 212, and an audio component 214.

The touchpad 100 of FIG. 2 can include one or more features similar to the touchpad 100 of FIG. 1, such as one or more contoured edges, one or more sensing areas, contours, textures, etc. The touchpad 100 can enable a user to interface with the system 200 or interact with the display component 204 by enabling the user to enter one or more inputs (e.g., to manipulate one or more objects of a UI on the display component 204). In this way, the touchpad may be configured to receive one or more inputs. Stated another way, the touchpad 100 can be a part of a human machine interface (HMI).

One or more portions or areas of the touchpad 100 can be formed to protrude, be contoured, textured, recessed, grooved, etc. to provide a user with one or more points of reference on the touchpad 100 while the user is operating a vehicle, thereby mitigating the user from being distracted, breaking his or her concentration, looking away from the road, etc.

In one or more embodiments the switch 202 of FIG. 2 can be the same switch as switch 102 of FIG. 1 or a different switch than the switch 102 of FIG. 1. Switch 202 and the touchpad 100 can be configured to receive one or more inputs. These inputs can include a variety of aspects. For example, an input can be a touch input, a click input, a toggle input, etc. That is, a touch input can be detected based on contact with a portion of a user, such as a finger. The click input may be received from clickable hardware, such as from a portion of the touchpad 100 (e.g., a clickable sensing area 110 of FIG. 1). The toggle input may be received from a component of the touchpad 100 or the switch 202 that is configured to toggle between two or more states. As an example, the switch 202 can be configured to be ‘on’ and ‘off’. Inputs may be associated with one or more sources (e.g., a swipe that originated from contoured edge 120A and terminated at sensing area 110). Inputs may be associated with a timer (e.g., how long a user holds a finger at a particular location). Additionally, inputs may be indicative of a number of touches (e.g., multi-touch input) from a source. For example, an input may be a one finger swipe, a two finger swipe, three finger swipe, etc.

The switch 202 can be configured to be customized or mapped to one or more functions. For example, if the switch 202 is configured to have an ‘on’ state and an ‘off’ state, an alert screen may be displayed on the display component 204 when the switch 202 is on, and a UI screen may be displayed on the display component 204 when the switch 204 is off. In other words, the switch 202 can be a mode independent notification feature that enables a user to toggle between two modes using a hardware switch. Stated another way, the switch 202 can act as a control mechanism that toggles the display component 204 between a UI screen and another featured screen (e.g., by enabling and cancelling or disabling one or more functions associated with the system or the featured screen). This enables a user to jump from one screen to another without navigating though software menus, for example.

In one or more embodiments, the switch 202 can be customized to toggle between two or more user selected screens. As an example, one of the user selected screens may be a notification screen associated with one or more notification functions or notification applications (e.g., emails, text messages, alerts, etc.). In this way, a user or driver can access two or more software screens without navigating through software, for example. In other embodiments, the UI component 206 can be configured to use a swipe from off-screen or a swipe that is associated with a contoured edge and the sensing area 110 to toggle between two or more user selected screens.

The UI component 206 can be configured to route one or more of the inputs to one or more UI applications. In other words, the UI component 206 can manage inputs from one or more users and execute one or more actions as a response from one or more of the UI applications. For example, the UI may include a home screen with one or more icons or one or more UI objects. When a user uses the touchpad 100 or switch 202 to click on one of the icons (e.g., provide an input), the UI component 206 can open a corresponding application, for example. In this way, the UI component 206 enables a user to manipulate one or more objects associated with one of more of the UI applications based on one or more of the inputs. For example, the UI component 206 may enable the user to manipulate one or more items or one or more objects displayed on the display component 204. These objects may be associated with one or more of the UI applications.

The display component 204 can be configured to display one or more aspects of a UI. The display component 204 can include a touch screen, a display, a heads up display (HUD), etc. The display component 204 can display the UI, one or more UI home screens, one or more of the UI applications, one or more user selected screens, one or more objects, one or more menus, one or more menu objects, one or more hints, etc. based on inputs from the touchpad 100 or switch 202 and the UI component 206.

In one or more embodiments, the UI can include a home screen with one or more icons or one or more icon objects. The UI can include a cursor which may be associated with the touchpad 100 or the switch 202. As an example, a cursor may be displayed by the display component 204 based on inputs received by the touchpad 100 or the switch 202. In one or more embodiments, the UI component 206 can be configured to enable selection of one or more menu items or one or more menu objects based on inputs received from the touchpad 100 or the switch 202. That is, for example, menu selections may be made by clicking one or more portions of the touchpad, such as a contoured edge or a sensing area, etc.

The UI component 206 can be configured to enable communication between input components such as the touchpad 100 or the switch 202 and one or more systems of the vehicle, one or more subsystems of the vehicle, one or more controller area networks (CANs, not shown), etc. For example, the touchpad 100 can be used as an input device for a navigation system on the vehicle. As another example, the touchpad 100 can be used as an input device in conjunction with a navigation application associated with or linked the vehicle. In other words, if a user plugs a mobile device equipped with a navigation application into the vehicle (e.g., via an interface component, not shown), the display component 204 may be configured to display content of the mobile device and the touchpad 100 can be configured to transmit one or more inputs received to the mobile device. Additionally, the UI component 206 can be configured to map content from the mobile device to the display component (e.g., by accounting for formatting, aspect ratio, etc.).

The UI component 206 can be programmed to respond to a variety of inputs received from the touchpad 100 and the switch 202. As an example, a two finger swipe associated with a contoured edge and a sensing area can be interpreted as a command to cycle to a next home screen. As another example, the UI component 206 may initiate a menu from a top portion of the display component 204 when an input associated with contoured edge 120A of FIG. 1 is received from the touchpad 100. In other words, the UI component 206 can be configured to display a menu that originates from a portion of a screen of the display component 204 based on an input received from a contoured edge. This can mean that an input associated with contoured edge 120C of FIG. 1 may result in a menu popping up from the bottom of the screen of display component 204.

In other embodiments, the UI component 206 can be customized to display menus based on one or more user preferences. For example, when a user indicates that he or she prefers ‘airplane’ controls or inverted controls, an input associated with contoured edge 120A of FIG. 1 may result in a menu appearing at the bottom of the screen of the display component 204. In other embodiments, inputs associated with one or more of the contoured edges or one or more other features of the touchpad 100 can be customized. This means that each one of the contoured edges, sensing areas, switches, etc. can be assigned custom functionality by a user. For example, a function can be used to inform a user of an operation (e.g., an application was opened).

The UI component 206 can be configured to perform one or more functions, such as scrolling, activating, selecting, providing hints, providing context, customizing settings to a user, locking a screen, providing alerts, etc. In one or more embodiments, one or more of the functions associated with the system 200 for user to vehicle interactions are notification functions related to alerts for phone messages, text messages, emails, alerts, etc.

In one or more embodiments, the touchpad 100 and the switch 202 can be laid out in an ergonomically friendly area, such as on a steering wheel of a vehicle or an armrest of the vehicle, thereby mitigating an amount of reaching a user or a driver may do in order to access an input component or device (e.g., the touchpad 100 or the switch 202). Similarly, the display component 204 can be placed in a manner that mitigates the amount of time a user or driver looks away from the road. For example, the display component 204 can be placed at eye level or project an image at eye level for a user or driver. Because the touchpad 100, switch 202, and display component 204 are layout independent, menu objects displayed by or on the display component 204 may not be obstructed by a user's finger when the user is accessing a menu object, thereby mitigating mistyping.

The hint component 208 can be configured to provide one or more hints or context sensitive help. What this means is that the hint component 208 can provide hints related to one or more potential inputs for one or more UI applications of a UI. Potential inputs may be associated with one or more features of one or more UI applications or the UI. In one or more embodiments, the UI component 206 may allow an action to be achieved through two or more different inputs. For example, a software button may enable a user to cycle or rotate through multiple home screens. The UI component 206 may also cycle or rotate through the multiple home screens when a two finger swipe is received from the touchpad 100. To this end, the hint component 208 may be configured to suggest the two finger swipe when the user uses the software button to cycle through the home screens, thereby alerting a user of one or more additional options or potential inputs, for example.

In one or more embodiments, the hint component 208 can provide one or more of the hints automatically, or in response to a user action, such as using the software button to cycle through home screens. In other embodiments, the hint component 208 can provide hints based on a user request, such as an input from the touchpad 100, for example. According to one or more embodiments, the hint component 208 can provide one or more hints when a multi-touch input is received from the touchpad 100. For example, when a user moves a cursor over an icon, object, UI application, etc. within the UI and holds two fingers on the touchpad 100, the hint component 208 can provide one or more hints related to that UI application. In other words, the hint component 208 can be configured to provide one or more of the hints based on a customizable or assignable input, such as a multi-finger or multi-touch input.

The hint component 208 can be configured to provide context hints, general hints, one or more hints at system boot up, or randomly. General hints may relate to the UI, while context hints may be associated with one or more aspects of a UI application. Additionally, the hint component 208 can be configured to provide hints based on features a user has not used or features that have not been activated within a timeframe, such as the past six months. In one or more embodiments, the hint component 208 can provide one or more of the hints based on inputs from the switch 202. For example, if the switch 202 is linked to a notification function when the switch 202 is in an ‘on’ position, and the user has an email message and a phone message when the switch is activated, the hint component 208 may provide a hint pertaining to an email UI application or a phone UI application.

According to one or more aspects, the hint component 208 can be associated with one or more UI applications, and be configured to provide one or more hints for one or more of the UI applications. This means that the hint component 208 can provide hints related to the UI applications. However, since a user may be more familiar with some of the UI applications that other UI applications, the hint components 208 can be configured to provide hints for different UI applications at one or more hint rates for one or more of the UI applications. That is, when a user is determined to be more familiar with one or more aspects of a UI application, the hint component 208 may not provide as many hints or may not provide hints as frequently for that UI application compared with a second UI application that the user is not as familiar with. The occurrence or hint rate associated with a UI application can be adjusted or decrease based on usage of the corresponding UI application. This means that eventually, hints may not be provided for one or more of the UI applications, for example.

In one or more embodiments, the hint component 208 can determine a familiarity level a user has with a UI application based on the multimedia component 210 or based on a connection to a mobile device. For example, if a user has a mobile device that is setup with a default email UI application by a first software vendor, the hint component 208 can be configured to infer that the user has a high familiarity level with software associated with the first software vendor. In other words, the hint component 208 can determine one or more familiarity levels a user has with one or more corresponding UI applications by analyzing one or more secondary sources, such as social media accounts, mobile device data, email accounts, etc.

As one example, the hint component 208 can access a vehicle history database (not shown) and submit a query to determine which vehicles a user has owned in the past. This enables the hint component 208 to make one or more inferences for one or more of the familiarity levels associated with one or more of the UI applications. For example, if the user owned a 2010 model of a vehicle associated with UI version 1.0 having a first UI application and a second UI application, and the user is currently driving a 2013 model with UI version 2.0 having the first UI application, a modified version of the second UI application, and a third UI application, the hint component may determine that the user has a high familiarity level with the first UI application, a moderate familiarity level with the second or modified version of the second UI application, and a low familiarity level with the third UI application.

A frequency or hint rate can be displayed for a user, to alert the user how often he or she can expect hints to appear in relation to a UI application. In one or more embodiments, the user can adjust one or more hint rates for one or more of the UI applications. As an example, if a user closes a hint for a UI application, the hint component 208 can be configured to decrease the hint rate for that UI application. According to one or more aspects, the hint rate for the UI application can be decreased based on a time that the hint was open. That is, the hint rate may be adjusted based on how quickly a user closes a hint. For example, if a user closes a hint for a UI application as soon as the hint is displayed on a frequent basis, the hint component 208 may draw an inference that the user does not want hints for that UI application. However, if the user closes the hint after thirty seconds, for example, the hint component 208 may draw an inference that the user read the hint, then closed it, and increase the hint rate accordingly (e.g., because the user is reading the hints).

In one or more embodiments, the hint component 208 can be linked to one or more user accounts. For example, the hint component 208 may be linked to a user account via the multimedia component 210 or via the fob component 212. The multimedia component 210 can be configured to associate the UI or UI component 206 with one or more multimedia accounts. For example, the multimedia component can connect or link the UI to a phone number, social media, one or more email accounts, etc. This means that UI applications managed by the UI component 206 may be associated with these accounts.

For example, the UI may include a text message UI application, one or more social media applications (e.g. for social media messages, instant messages), one or more email applications, a telephone application (e.g. for missed calls, voicemail), etc. The multimedia component 210 can be configured to link corresponding accounts to the system 200. In this way, the hint component 208 may be configured to identify a user. That is, when a first user signs out of a social media UI application and a second user signs into the social media UI application via the multimedia component 210, the hint component 208 can provide hints for the second user based on information related to the second user accordingly.

Similarly, the fob component 212 can be configured to identify one or more user associated with the system 200. For example, the fob component 212 can interact with the multimedia component 210 to associate the system with one or more accounts associated with a user. That is, the fob component 212 can be configured to sign a first user out of one or more social media accounts, email accounts, etc. associated with one or more UI applications and sign a second user into one or more social media accounts, email accounts, etc. for one or more of the UI applications. Additionally, the fob component 212 can be configured to provide one or more privacy options for one or more of the users. For example, the fob component 212 can enable a first user to lock other users out of his or her settings or UI applications by requiring a PIN at logon, etc. In this way, one or more UI applications can be customized to one or more of the users.

In one or more embodiments, the audio component 214 can be configured to provide one or more audio alerts for one or more of the UI applications. For example, the audio component 214 can provide text to speech (TTS) when the switch 202 is in an ‘on’ state to notify a user of one or more alerts, messages, or notifications, etc. In other embodiments, the audio component can be configured to narrate one or more active functions, one or more potential actions, etc. aloud to a user or driver, thereby facilitating safer driving.

FIG. 3 is an illustration of an example system 300 for user to vehicle interaction, according to one or more embodiments. The system 300 can include a display component 204, a UI component (not shown), and a touchpad 100. The touchpad 100 can include one or more sensing areas 110 and one or more contoured edges 120. According to one or more aspects, the touchpad 100 can have a recess at location 304. The recess can be used as a point of reference for a driver such that a cursor 302 can be displayed on the display component 204 at a center location corresponding to location 304, for example. The touchpad 100 can be used to enable navigation through a UI, wherein the UI can include one or more objects, such as menu objects 310, 320, 330, etc. In one or more embodiments, one or more of the menu objects 310, 320, or 330 can be hidden by the UI component when no activity or input is detected by the touchpad 100. This enables toggling between UI applications and inputs or menus.

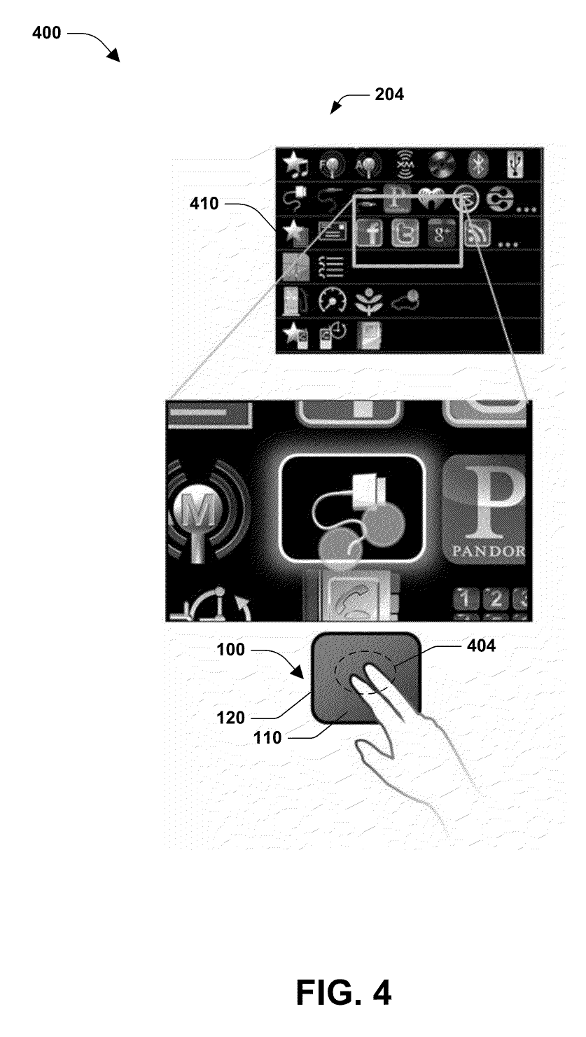

FIG. 4 is an illustration of an example system 400 for user to vehicle interaction, according to one or more embodiments. In one or more embodiments, the touchpad 100 can be configured to accept multi-touch or multi-finger inputs, as shown at 404. The UI 410 can be configured to react to a variety of inputs accordingly. For example, the UI 410 may be configured to provide one or more hints when a multi-touch input is received from the touchpad 100.

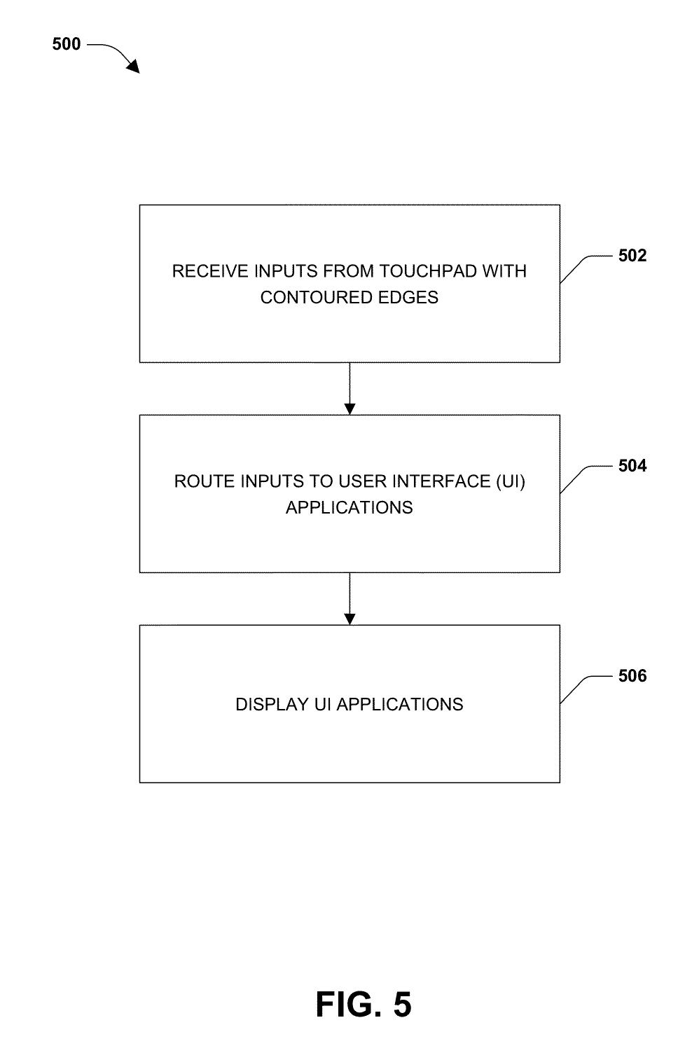

FIG. 5 is an illustration of an example flow diagram of a method 500 for user to vehicle interaction, according to one or more embodiments. At 502, one or more inputs can be received from a touchpad, where the touchpad include one or more contoured edges. The touchpad can have one or more contours within one or more sensing areas. For example, the touchpad can have one or more recesses, peaks, grooves, etc. At 504, one or more of the inputs can be routed to one or more user interface (UI) applications. At 506, one or more of the UI applications can be displayed. Additionally, one or more hints may be provided based on one or more familiarity levels. One or more of the familiarity levels may be estimated based one or more linked accounts, one or more user inputs, timings associated therewith, or historical data (e.g., interfaces which a user has interacted with previously, etc.).

Users of the touchpad may include drivers, operators, occupants, passengers, etc. Accordingly embodiments are not necessarily limited to the context of operating a vehicle. For example, a touchpad as disclosed herein can be used in other applications or for other endeavors, such as computing, gaming, etc. without departing from the spirit or scope of the disclosure.

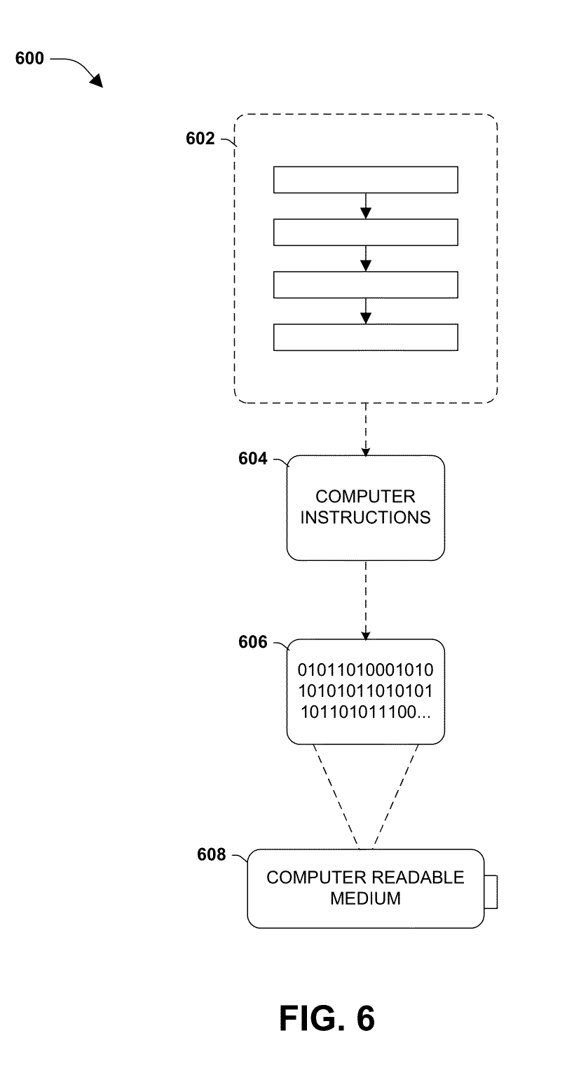

Still another embodiment involves a computer-readable medium including processor-executable instructions configured to implement one or more embodiments of the techniques presented herein. An embodiment of a computer-readable medium or a computer-readable device that is devised in these ways is illustrated in FIG. 6, wherein an implementation 600 includes a computer-readable medium 608, such as a CD-R, DVD-R, flash drive, a platter of a hard disk drive, etc., on which is encoded computer-readable data 606. This computer-readable data 606, such as binary data including a plurality of zero's and one's as shown in 606, in turn includes a set of computer instructions 604 configured to operate according to one or more of the principles set forth herein. In one such embodiment 600, the processor-executable computer instructions 604 are configured to perform a method 602, such as the method 500 of FIG. 5. In another embodiment, the processor-executable instructions 604 are configured to implement a system, such as the system 200 of FIG. 2. Many such computer-readable media are devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

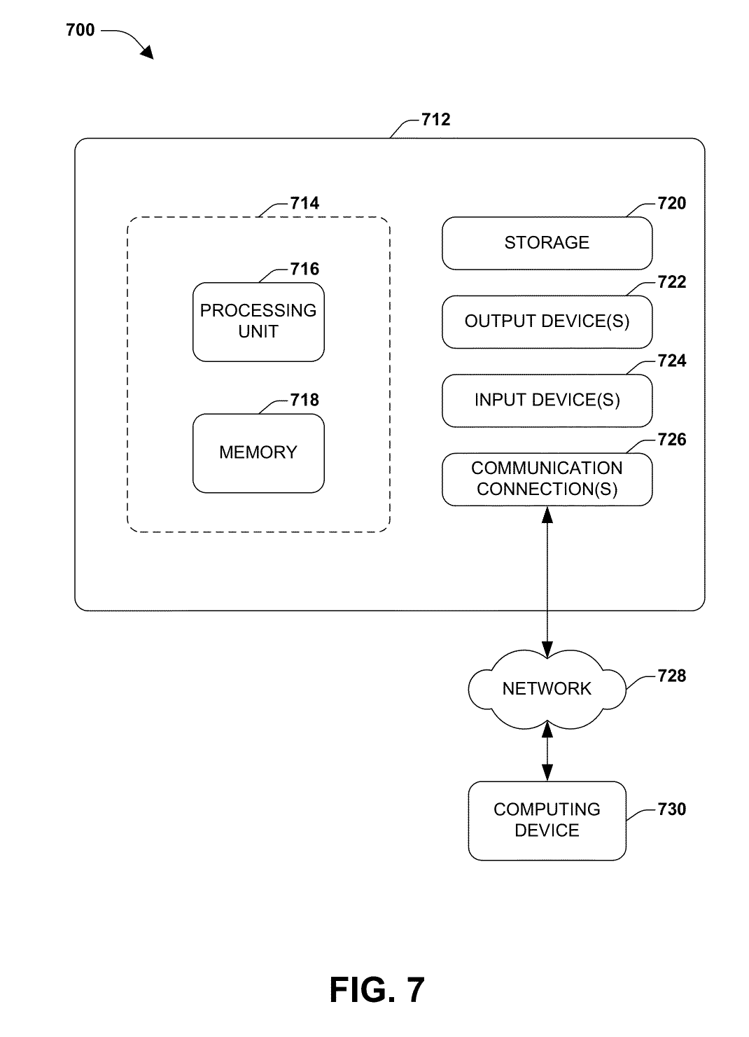

FIG. 7 and the following discussion provide a description of a suitable computing environment to implement embodiments of one or more of the provisions set forth herein. The operating environment of FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, and the like.

Generally, embodiments are described in the general context of “computer readable instructions” being executed by one or more computing devices. Computer readable instructions are distributed via computer readable media as will be discussed below. Computer readable instructions are implemented as program modules, such as functions, objects, Application Programming Interfaces (APIs), data structures, and the like, that perform particular tasks or implement particular abstract data types. Typically, the functionality of the computer readable instructions are combined or distributed as desired in various environments.

FIG. 7 illustrates a system 700 including a computing device 712 configured to implement one or more embodiments provided herein. In one configuration, computing device 712 includes at least one processing unit 716 and memory 718. Depending on the exact configuration and type of computing device, memory 718 may be volatile, such as RAM, non-volatile, such as ROM, flash memory, etc., or a combination of the two. This configuration is illustrated in FIG. 7 by dashed line 714.

In other embodiments, device 712 includes additional features or functionality. For example, device 712 also includes additional storage such as removable storage or non-removable storage, including, but not limited to, magnetic storage, optical storage, and the like. Such additional storage is illustrated in FIG. 7 by storage 720. In one or more embodiments, computer readable instructions to implement one or more embodiments provided herein are in storage 720. Storage 720 also stores other computer readable instructions to implement an operating system, an application program, and the like. Computer readable instructions are loaded in memory 718 for execution by processing unit 716, for example.

The term “computer readable media” as used herein includes computer storage media. Computer storage media includes volatile and nonvolatile, removable and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 712. Any such computer storage media is part of device 712.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 712 includes input device(s) 724 such as keyboard, mouse, pen, voice input device, touch input device, infrared cameras, video input devices, or any other input device. Output device(s) 722 such as one or more displays, speakers, printers, or any other output device are also included in device 712. Input device(s) 724 and output device(s) 722 are connected to device 712 via a wired connection, wireless connection, or any combination thereof. In one or more embodiments, an input device or an output device from another computing device are used as input device(s) 724 or output device(s) 722 for computing device 712. Device 712 also includes communication connection(s) 726 to facilitate communications with one or more other devices.

According to one or more aspects, a system for user to vehicle interaction is provided, including a touchpad configured to receive one or more inputs. The touchpad can include one or more sensing areas and one or more contoured edges. One or more of the contoured edges can be configured to sense one or more of the inputs for the touchpad. The system can include a user interface (UI) component configured to route one or more of the inputs to one or more UI applications. The system can include a display component configured to display one or more of the UI applications. The UI component may be configured to manipulate one or more objects associated with one or more of the UI applications based on one or more of the inputs received by the touchpad.

In one or more embodiments, the system may include a multimedia component configured to associate the UI component with one or more multimedia accounts, a hint component configured to provide one or more hints related to one or more potential inputs for one or more of the UI applications, a switch configured to enable or disable one or more functions associated with the system for user to vehicle interaction, or a fob component configured to customize one or more of the UI applications for one or more users.

One or more of the contoured edges may be elevated relative to one or more of the sensing areas. Alternatively, one or more of the sensing areas may be elevated relative to one or more of the contoured edges. Additionally, one or more of the contoured edges can be configured to sense one or more of the inputs for the touchpad. For example, one or more of the contoured edges can be clickable or touch sensitive. Similarly, one or more of the sensing areas can be configured to sense one or more of the inputs for the touchpad.

According to one or more aspects, a method for user to vehicle interaction is provided, including receiving one or more inputs via a touchpad or a switch, where the touchpad can include one or more sensing areas and one or more contoured edges, where one or more of the contoured edges can be configured to sense one or more of the inputs for the touchpad. The method can include routing one or more of the inputs to one or more user interface (UI) applications and displaying one or more of the UI applications.

The method can include providing one or more hints related to one or more potential inputs for one or more of the UI applications. For example, providing one or more of the hints may be based on a multi-finger input. The method can include manipulating one or more objects associated with one or more of the UI applications based on one or more of the inputs. A source of an input can be traced to one of the sensing areas or one of the contoured edges. For example, the method can include associating one or more of the inputs with one or more of the sensing areas of the touchpad, one or more of the contoured edges of the touchpad, or the switch. Additionally, user to vehicle interaction can be customized for different users. For example, the method can include identifying one or more users associated with one or more of the inputs for the user to vehicle interaction.

According to one or more aspects, a system for user to vehicle interaction is provided, including a touchpad configured to receive one or more inputs, where the touchpad can include one or more sensing areas and one or more contoured edges. One or more of the contoured edges can be configured to sense one or more of the inputs for the touchpad. The system can include a switch configured to enable or disable one or more functions associated with the system for user to vehicle interaction, a user interface (UI) component configured to route one or more of the inputs to one or more UI applications, and a display component configured to display one or more of the UI applications. In one or more embodiments, the system includes an audio component configured to provide one or more audio alerts associated with one or more of the UI applications. The system can include a hint component configured to provide one or more hints related to one or more potential inputs for one or more of the UI applications. One or more of the functions associated with the system for user to vehicle interaction can be notification functions.

Although the subject matter has been described in language specific to structural features or methodological acts, it is to be understood that the subject matter of the appended claims is not necessarily limited to the specific features or acts described above. Rather, the specific features and acts described above are disclosed as example embodiments.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or”. In addition, “a” and “an” as used in this application are generally construed to mean “one or more” unless specified otherwise or clear from context to be directed to a singular form. Also, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel.

Also, although the disclosure has been shown and described with respect to one or more implementations, equivalent alterations and modifications will occur based on a reading and understanding of this specification and the annexed drawings. The disclosure includes all such modifications and alterations and is limited only by the scope of the following claims.

What is claimed is:

1. A system for user to vehicle interaction, comprising:
a touchpad configured to receive one or more inputs, the touchpad comprising:
one or more sensing areas; and
one or more contoured edges, wherein one or more of the contoured edges are configured to sense one or more of the inputs for the touchpad;
a user interface (UI) component configured to route one or more of the inputs to one or more UI applications; and
a display component configured to display one or more of the UI applications, wherein the UI component is implemented via a processing unit.

2. The system of claim 1, comprising a multimedia component configured to associate the UI component with one or more multimedia accounts.

3. The system of claim 1, comprising a hint component configured to provide one or more hints related to one or more potential inputs for one or more of the UI applications.

4. The system of claim 1, comprising a switch configured to enable or disable one or more functions associated with the system for user to vehicle interaction.

5. The system of claim 1, comprising a fob component configured to customize one or more of the UI applications for one or more users.

6. The system of claim 1, wherein one or more of the contoured edges are elevated relative to one or more of the sensing areas.

7. The system of claim 1, wherein one or more of the sensing areas are elevated relative to one or more of the contoured edges.

8. The system of claim 1, the UI component configured to manipulate one or more objects associated with one or more of the UI applications based on one or more of the inputs received by the touchpad.

9. The system of claim 1, wherein one or more of the contoured edges are clickable or touch sensitive.

10. The system of claim 1, wherein one or more of the sensing areas are configured to sense one or more of the inputs for the touchpad.

11. A method for user to vehicle interaction, comprising:
receiving one or more inputs via a touchpad or a switch, the touchpad comprising:
one or more sensing areas; and
one or more contoured edges, wherein one or more of the contoured edges are configured to sense one or more of the inputs for the touchpad;
routing one or more of the inputs to one or more user interface (UI) applications; and
displaying one or more of the UI applications, wherein the receiving, the routing, or the displaying is implemented via a processing unit.

12. The method of claim 11, comprising providing one or more hints related to one or more potential inputs for one or more of the UI applications.

13. The method of claim 12, wherein providing one or more of the hints is based on a multi-finger input.

14. The method of claim 11, comprising manipulating one or more objects associated with one or more of the UI applications based on one or more of the inputs.

15. The method of claim 11, associating one or more of the inputs with one or more of the sensing areas of the touchpad, one or more of the contoured edges of the touchpad, or the switch.

16. The method of claim 11, comprising identifying one or more users associated with one or more of the inputs for the user to vehicle interaction.

17. A system for user to vehicle interaction, comprising:
a touchpad configured to receive one or more inputs, the touchpad comprising:
one or more sensing areas; and
one or more contoured edges, wherein one or more of the contoured edges are configured to sense one or more of the inputs for the touchpad;
a switch configured to enable or disable one or more functions associated with the system for user to vehicle interaction;
a user interface (UI) component configured to route one or more of the inputs to one or more UI applications; and
a display component configured to display one or more of the UI applications, wherein the UI component is implemented via a processing unit.

18. The system of claim 17, comprising an audio component configured to provide one or more audio alerts associated with one or more of the UI applications.

19. The system of claim 17, wherein one or more of the functions associated with the system for user to vehicle interaction are notification functions.

20. The system of claim 17, comprising a hint component configured to provide one or more hints related to one or more potential inputs for one or more of the UI applications.
